(19) United States
(12) Patent Application Publication
(10) Pub. No.: US 2005/0021339 A1
(43) Pub. Date: Jan. 27, 2005

(54) Annotations addition to documents rendered via text-to-speech conversion over a voice connection

(75) Inventor: Johannes Ruetschi, Delray Beach, FL (US)

Correspondence Address: Elsa Keller;Siemens Corporation, Intellectual Property Department, 170 Wood Avenue South, Iselin, NJ, 08830, US

(73) Assignee: Siemens Information and Communication Networks, Inc.

(21) Appl. No.: 10/625,960

(22) Filed: Jul. 24, 2003

(51) Int. Cl. G10L 13/00

(52) U.S. Cl. 704/269

(57) ABSTRACT

A method and an apparatus for using speech to annotate text messages over a voice connection. The present invention allows the insertion of a plurality of annotations in the message, while the message is being rendered vocally using a Text-to-Speech (TTs) conversion. The invention interactively integrates TTS conversion, Automatic Speech Recognition (ASR), Interactive Voice Response (IVR) system and the execution of office document applications within the Unified Messaging System.

### FIELD OF THE INVENTION

The present invention relates generally to Unified Messaging, and specifically, to a method and an apparatus for inserting text or sound annotations into messages delivered over a voice connection.

### BACKGROUND OF THE INVENTION

Users of modern communication tend to exchange various kinds of messages, including e.g. voice mail, fax, video messages, electronic mail (email) and attachments to email. While this plethora of message types provides flexibility for users, users are required to have access to different retrieval devices in order to recover these various message types (e.g. personal computers, Personal Digital Assistants (PDA), fax machines, pagers, cellular telephones and landline telephones, etc.) which results in requiring the management of multiple mail boxes. Furthermore, the ability to monitor such a plurality of mailboxes for the arrival of new messages is cumbersome. The difficulty is compounded when access to the proper retrieval device is not available, especially, for example, when the user is traveling away from the office. Unified Messaging (UM) addressed these problems by providing a way for all message types to be sent to a single consolidated mailbox from which all messages can be retrieved using a single communication device, regardless of the message type.

Accordingly, it is know in the art that users can access the consolidated Unified Messaging mailbox and retrieve text messages (e.g. email messages) over a telephone voice connection using a Text-To-Speech (TTS) conversion engine. It is also possible for users to utilize the Interactive Voice Response (IVR) system and Automatic Speech Recognition (ASR) software to convert the user's vocal commands into text messages understood by the communication system. Callers to the voice mail system may use telephone keypad or voice commands to effect limited rudimentary interaction with a recorded message, e.g. listen, delete, forward, temporarily halt or stop message delivery, etc.

However, current message delivery methods are not known to allow more sophisticated message interaction by users such as to edit the recorded message such as to insert commentary or other annotation. At the present time, a telephone user, who is receiving an email message over a voice connection using the TTS conversion provided by the Unified Messaging system, has no way of annotating the message being delivered with notes and comments.

The prior art is especially limiting in this regard when rendering text messages that include attachments in various formats (e.g., Word Processor, Spreadsheet, and Presentations). Since these messages tend to be lengthy and have a propensity to contain a plurality of segments, responding to such messages is likely to require more time to prepare. Under such circumstance, the ability to insert comments in or otherwise annotate the delivered message at one or more desired points would be very advantageous. The present invention is especially valuable for those whose ability to compose written notes is severely restricted, for example drivers or people otherwise occupied with a different primary task.

### SUMMARY AND OBJECTS OF THE INVENTION

The foregoing and other problems and deficiencies in the prior art are overcome by the present invention, which gives users of Unified Messaging the ability to annotate messages and attachments rendered via TTS over a voice connection.

One aspect of the present invention is that it enables the voice mail rendering system to incorporate an editing capability.

Another aspect of the present invention is that TTS delivery systems recognize and accept annotation commands.

A further object of the present invention is the ability to accept voice annotations using Automatic Speech Recognition (ASR).

It is yet another aspect of the present invention to provide the ability to accept voice annotations using an Interactive Voice Response (IVR) system.

Further, it is an object of the present invention to provide a method and an apparatus for annotating native text email messages using voice commands.

It is also an object of the present invention to provide a method and an apparatus for annotating a document attached to email messages using voice commands.

It is another object of the present invention to provide a method and an apparatus for annotating native voice messages using voice commands.

It is still another object of this invention to allow users to save the annotated messages for later access.

It is yet another object of the present invention to allow users to forward annotated messages to other users.

### BRIEF DESCRIPTION OF THE DRAWINGS

The foregoing objects are achieved and other features and advantages of the present invention will become more apparent in light of the following detailed description of exemplary embodiments thereof, as illustrated in the accompanying drawings, where:

FIG. 1 is a schematic block diagram of the connectivity between the various elements of the Unified Messaging system according to an illustrative embodiment of the present invention.

FIG. 2 is a flow diagram of an illustrative embodiment for the steps involved in annotating a text message rendered using TTS over a voice connection.

### DETAILED DESCRIPTION

Generally, under the present invention, a telephone user retrieving email messages from a Unified Messaging server over a voice connection is given the capability to add vocal (speech) annotations to the rendered message. The added vocal annotations are then converted into text, or alternatively saved as a sound file, and inserted into the original message.

The invention will now be described in detail with reference to the accompanying drawings.

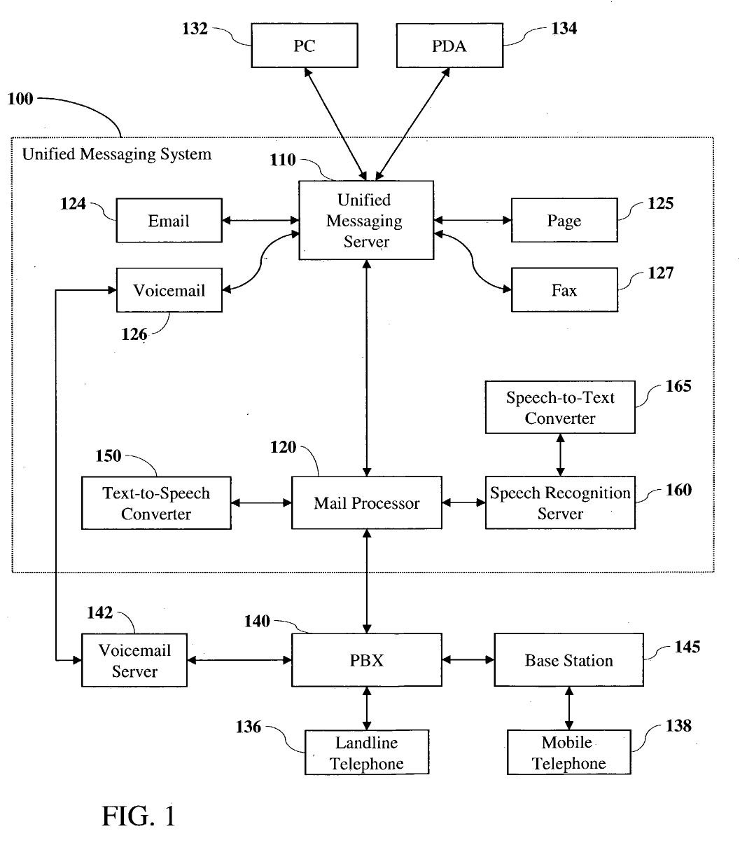

FIG. 1 represents a Unified Messaging system 100 under an illustrative embodiment of the present invention. The Unified Messaging server 110 is a universal hub that receives, sends and stores all types of messages (including e.g. email 124, page 125, voice mail 126 and fax 127) within the Unified Messaging system 100. The Unified Messaging server 110 collects all mail messages and consolidates them at a single location. Different types of mail messages may reside in a single unified server, or on different servers as required for a particular application. For example, the voicemail server 142 can be part of the PBX 140 (as shown), or it can be integrated with the Unified Messaging system 100. It will be understood by those of ordinary skill in the art that the various entities making up the Unified Messaging system 100 represent logical blocks, which may be described as one or more physical entities.

Messages residing at the Unified Messaging server 110 may be accessed directly using an interface device, e.g. by direct connection via a Personal Computer (PC) 132 or a PDA 134 or via a voice connection using a landline telephone 136 or a mobile telephone 138. The connection between the landline telephone 136 or the mobile telephone 138 and the Unified Messaging server 110 is established through Private Branch Exchange (PBX) 140 and mail processor 120. For the mobile telephone 138, the connection to the PBX 140 also typically passes through a wireless base station 145.

The retrieval of messages using landline telephones 136 or mobile telephones 138 requires the use of mail processor 120. The TTS converter 150 allows text messages in the Unified Messaging mailbox to be delivered as speech to the landline telephone 136 or the mobile telephone 138. Speech recognition server 160 and Speech-to-Text converter 165, on the other hand, allow the user's spoken language to be converted into text messages before it gets transmitted to the Unified Messaging server 110.

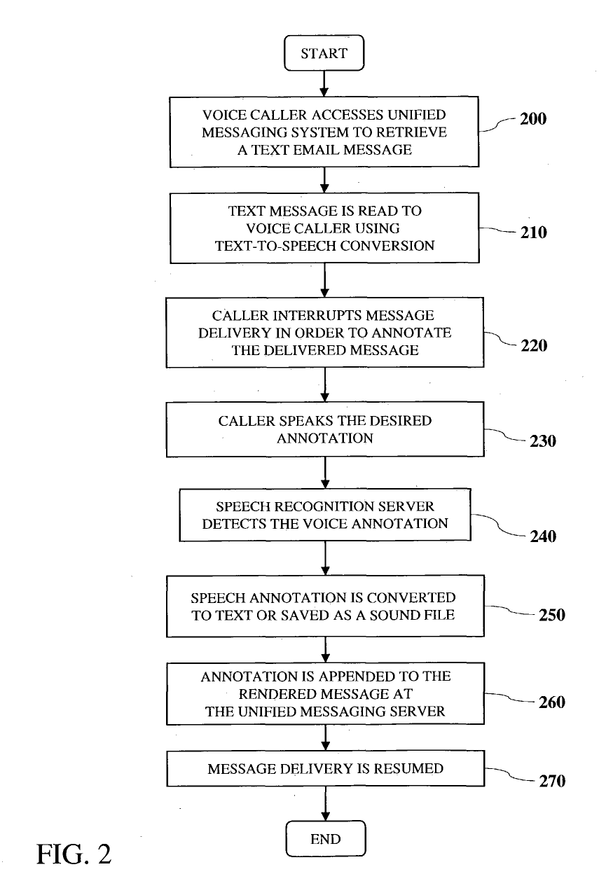

FIG. 2 is an example of a flow diagram for verbally annotating a text message under an illustrative embodiment of the present invention. In this embodiment the interface device is implemented via a voice connection. A caller uses a mobile telephone or a landline telephone to call the Unified Messaging server and access a message at 200. The message can be a text message that may or may not contain attachments. Subsequently, the text message is converted to speech using the TTS engine, and the message is read to the voice caller over the voice connection at 210. Based on the user's preference, email attachments may be converted to speech and read to the caller over the voice connection. If the user decides to annotate the message at 220, the user speaks a command phrase such as “STOP. INSERT COMMENT” to temporary halt the message delivery and to indicate the desire to annotate the rendered message. The Automatic Speech Recognition (ASR) software detects the user's verbal command and prompts the user to dictate the desired annotation. In one embodiment, the Interactive Voice Response (IVR) system is used to indicate readiness to receive the dictation by informing the caller that the system is, e.g., “READY TO INSERT COMMENT”, or other similar feedback. The caller then speaks the desired annotation at 230, e.g. “ADD TABLE TO DOCUMENT”, or any other desired annotation. In this exemplary embodiment, the annotation ends when the ASR detects the phrase “END COMMENT”, or any other phrase that is previously defined by the user for this purpose.

Alternatively, the annotation process can also be controlled using Dual Tone Multi-Frequency (DTMF) tones. Telephone keys can be defined to initiate, stop or perform other functions related to message annotations.

The annotated speech is detected by the ASR at 240 and then gets converted to text using the Speech-to-Text conversion at 250. Natural Language Processing (NLP) may be used to improve the accuracy of the Speech-to-Text translation. Alternatively, the annotated speech at 240 is saved as a sound file at 250.

In one embodiment of the invention, the user may request to have the annotated information be read back for verification. Further, the caller may accept, reject or edit the annotation. When the caller completes the annotation, the text of the annotated speech (or the sound file) is inserted in the original message at 260. The present invention allows the annotated text to be inserted at the point where the message delivery stopped, at the beginning of the message or at the end of the message. In the exemplary embodiment, message rendering is resumed at 270 when the phrase “RESUME MESSAGE” or similar command predetermined by the individual user is detected. According to the present invention, message annotation can be initiated again at a later insertion point, if requested by the caller by repeating the foregoing whenever subsequent annotation is desired.

When the caller completes rendering the message, the caller may be asked (preferably using IVR system) to decide if the annotated (edited) message is to be saved as a new message or to replace the original message. Subsequently, the caller may choose to access a different message, forward the original or annotated message to another user, terminate the session with the Unified Messaging mailbox, or choose any other available option.

At a later time, when the caller accesses the annotated message, the annotations will have been incorporated into the original message or attachment. In one embodiment, when viewing the annotated message by a text application (e.g. Microsoft Word), the annotated text will be shown, e.g. in a different color or font, to make it distinguishable from the original message.

The present invention allows the user to define various vocal commands for controlling the Unified Messaging mailbox access and the message annotation process as will be understood. For example, the user may choose to define customized vocal commands for starting, temporarily halting or ending message delivery. Similarly, the user may choose to define vocal commands for starting and ending the annotation process. In a different embodiment of the present invention, the telephone keypad is used, in conjunction with the IVR system, to deliver commands instructing the Unified Messaging system to start or end the annotation process. Furthermore, under the present invention the caller may use a combination of keypad and voice commands to perform the annotation.

The present invention is not limited to annotating office documents and text email messages. The invention can be used to annotate native voice messages (messages that are stored as voice) as well. In such cases, there will be no need for TTS conversion during message delivery and neither the vocal annotations nor the annotated voice message will be converted to text.

Without departing from the spirit and scope of the invention. It is therefore intended that the present invention is not limited to the disclosed embodiments described herein but should be defined in accordance with the claims that follow.

1. A method for inserting a caller's speech annotations into an original message, comprising the steps of:
providing a speech rendering of said original message;
annotating said speech message with at least one speech annotation; and
inserting said speech annotation into said original message.

2. The method of claim 1 wherein said original message is a text email message.

3. The method of claim 1 wherein said original message contains at least one attached document.

4. The method of claim 1 wherein said original message is a voice message.

5. The method according to claim 2 wherein said step of providing a speech rendering of said original message comprises converting said text message to speech.

6. The method according to claim 3 wherein said step of providing a speech rendering of said original message comprises converting said attachment to speech.

7. The method according to claim 1 further comprising the step of connecting to the mailbox of said email message by establishing a voice connection using a landline telephone or a mobile telephone.

8. The method of claim 1 wherein said annotating step includes recognition of predefined commands for starting and stopping said speech annotation.

9. The method of claim 8 wherein said commands are speech commands.

10. The method of claim 8 wherein said commands are entered via Dual Tone Multi-Frequency (DTMF) tones.

11. The method of claim 8 further comprising the step of using an interactive voice response (IVR).

12. The method according to claim 8 wherein said speech commands are user defined.

13. The method of claim 1 further comprising the step of recognizing said speech annotations of said caller.

14. The method according to claim 1 further comprising the step of converting said speech annotations to text.

15. The method of claim 14 wherein said step of converting annotated voice command to text is accomplished using Automatic Speech Recognition (ASR) and Speech-to-Text conversion.

16. The method of claim 1 wherein said speech annotation is inserted in said original message in text format.

17. The method of claim 1 wherein said speech annotation is inserted in said original message as a sound file.

18. The method of claim 1 further comprising the step of storing said annotated message at the Unified Messaging server after inserting said speech annotation into said message.

19. The method according to claim 18 wherein said step of storing said annotated message includes creating a new copy of said message.

20. The method according to claim 1 further comprising the step of forwarding said annotated message to another user.

21. An apparatus for inserting a caller's speech annotations into an original message, comprising:
means for providing speech rendering of said original message;
means for annotating said speech message with at least one speech annotation; and
means for inserting said speech annotation into said original message.

22. The apparatus of claim 21 wherein said original message is a text email message.

23. The apparatus of claim 21 wherein said original message contains at least one attached document.

24. The apparatus of claim 21 wherein said original message is a voice message.

25. The apparatus according to claim 22 wherein said means of providing a speech rendering of said original message comprises means for converting said text message to speech.

26. The apparatus according to claim 23 wherein said means of providing a speech rendering of said original message comprises means for converting said attachment to speech.

27. The apparatus according to claim 21 further comprising means for connecting to the mailbox of said email message by establishing a voice connection using a landline telephone or a mobile telephone.

28. The apparatus of claim 21 wherein said annotating means includes means for recognition of commands for starting and stopping said speech annotation.

29. The apparatus of claim 28 wherein said commands are speech commands.

30. The apparatus of claim 28 wherein said commands are entered via Dual Tone Multi-Frequency (DTMF) tones.

31. The apparatus of claim 28 further incorporating the interactive voice response (IVR).

32. The apparatus according to claim 28 wherein said speech commands are user defined.

33. The apparatus of claim 21 further comprising means for recognizing said speech annotations of said caller.

34. The apparatus according to claim 21 further comprising means for converting said speech annotations to text.

35. The apparatus of claim 34 wherein said means of converting annotated voice command to text is accomplished using Automatic Speech Recognition (ASR) and Speech-to-Text conversion.

36. The apparatus of claim 21 wherein said speech annotation is inserted in said original message in text format.

37. The apparatus of claim 21 wherein said speech annotation is inserted in said original message as a sound file.

38. The apparatus of claim 21 further comprising means for storing said annotated message at the Unified Messaging server after inserting said speech annotation into said message.

39. The apparatus according to claim 38 wherein said means of storing said annotated message includes creating a new copy of said message.

40. The apparatus according to claim 21 further comprising the means for forwarding said annotated message to another user.
